(19) United States
(12) Patent Application Publication
(10) Pub. No.: US 2010/0318449 A1
(43) Pub. Date: Dec. 16, 2010

(54) Electronic accounting machine with overdraft warning

(76) Inventor: Jack Tang, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/458,057

(22) Filed: Jun. 30, 2009

(30) Foreign Application Priority Data
Jun. 12, 2009 (TW) 98210617

(51) Int. Cl. G06Q 40/00

(52) U.S. Cl. 705/35

(57) ABSTRACT

An electronic accounting machine includes a housing, a display screen carrying a set of icons and defining a numeric data display zone, a set of numeric keys, a set of function keys, an operation and memory circuit having an Autorun Program, an account statement and a warning program, the account statement featuring a plurality of items of expenditure, each item of expenditure having an early-warning threshold value and a cumulative expenditure value, the warning program executing a warning action when the cumulative expenditure value surpasses said early-warning threshold value, and a connection interface electrically connected to the operation and memory circuit for connecting to an external computer for enabling the Autorun Program to run automatically and to let a user of the external computer access to the account statement.

### BACKGROUND OF THE INVENTION

1. Field of the Invention

The present invention relates to accounting apparatus, and more particularly, to an electronic accounting machine for accounting for sorted expenses, which gives a warning signal when the expenditure on one specific item reaches a predetermined threshold value.

2. Description of the Related Art

An electronic accounting machine has an architecture similar to a calculator. It achieves accounting for expenses by means of calculator computing and number keys input functions incorporation with pre-set expenditure items (such as dress expenditure, food expenditure).

Taiwan Patent Publication Number 564,975 discloses an accounting machine entitled “Computing device with classified accounts”. This disclosure incorporates an accounting function into a calculator for recording expenditures on Food, Clothes, Living, Transportation, Education and Entertainment in respective accounts, thereby achieving accounting.

However, conventional electronic accounting machines are to be used simply for classified accounting, they do not provide any overdraft warning or reminding functions.

### SUMMARY OF THE INVENTION

The present invention has been accomplished under the circumstances in view. It is the main object of the present invention to provide an electronic accounting machine with pre-overdraft warning, which gives a warning signal when the expenditure on one specific item reached a predetermined allowance.

It is another object of the present invention to provide an electronic accounting machine with pre-overdraft warning, which is connectable to a computer and automatically runs the built-in autorun program upon connection to a computer, enabling the user to access to the storage account statement, facilitating accounting.

To achieve this and other objects of the present invention, an electronic accounting machine comprises a housing, a display screen mounted on the housing and carrying multiple icons, which are controllable to display or not to display, and defining a numeric data display zone, a set of numeric keys featuring digits 0 to 9 and a decimal point (.), a set of function keys mounted on the surface of the housing and including two directional keys, an OK (ENTER) key, an alter key and multiple operation keys, an operation and memory circuit electrically connected with the set of numeric keys, the set of function keys and the display screen, the operation and memory circuit comprising an Autorun Program, an account statement and a warning program, and a connection interface electrically connected to the operation and memory circuit for connecting to an external computer for enabling the Autorun Program to run automatically and to let a user of the external computer access to the account statement. The warning program executes a warning action when the cumulative expenditure value surpasses the early-warning threshold value.

### BRIEF DESCRIPTION OF THE DRAWINGS

FIG. 1 is a front view of an electronic accounting machine in accordance with the preferred embodiment of the present invention.

FIG. 2 is a bottom view of the electronic accounting machine in accordance with the preferred embodiment of the present invention.

FIG. 3 is a circuit block diagram of the electronic accounting machine in accordance with the preferred embodiment of the present invention,

FIG. 4 is a schematic drawing showing an account statement according to the present invention.

FIG. 5 is a schematic applied view of the present invention, showing electronic accounting machine connected to a computer.

### DETAILED DESCRIPTION OF THE INVENTION

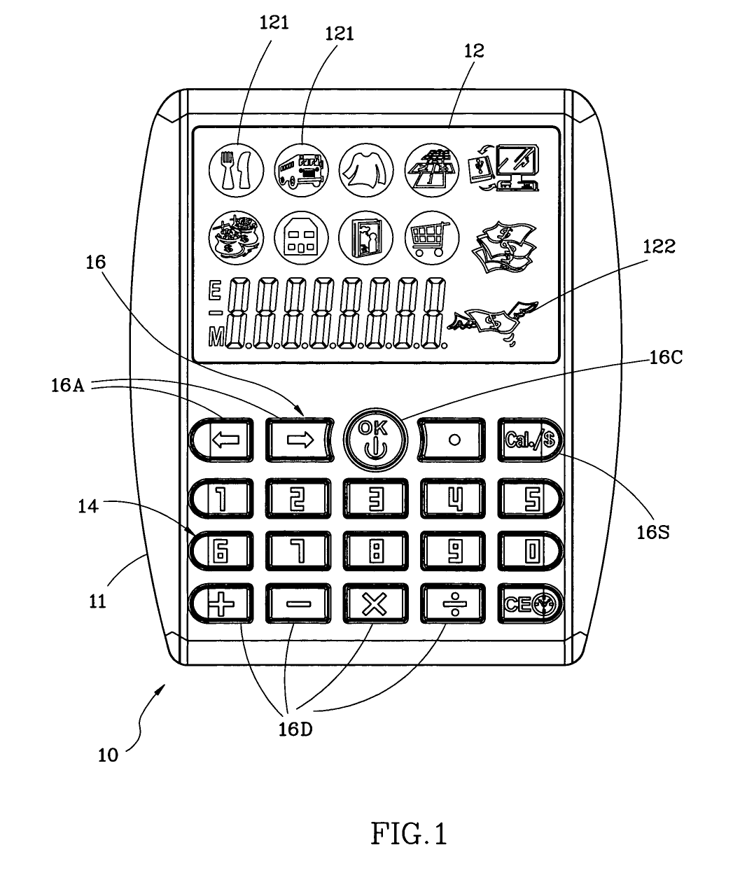

Referring to FIGS. 1˜4, an electronic accounting machine 10 in accordance with the preferred embodiment of the present invention is shown comprising a housing 11, a display screen 12, a set of numeric keys 14, a set of function keys 16, an operation and memory circuit 21, a speaker 18 and a connection interface 19.

The display screen 12 is mounted on the housing 11, carrying a number of icons 121 controllable to display or not to display. The display screen 12 also defines a numeric data display zone. The display locations of the icons 121 are at the top side relative to the numeric data display zone. The icons 121 include a food expenditure icon, a transportation expenditure icon, a clothing expenditure icon, an entertainment expenditure icon, a fixed cost icon, a housing expenditure icon, an education expenditure ion and an other-expenditure icon.

The set of numeric keys 14 is mounted on the surface of the housing 11 below the display screen 12, featuring digits 0 to 9 and a decimal point (.).

The set of function keys 16 is mounted on the surface of the housing 11 below the display screen 12, including two directional keys 16A, an OK (ENTER) key 16C, an Alter key 16S and multiple operation keys 16D.

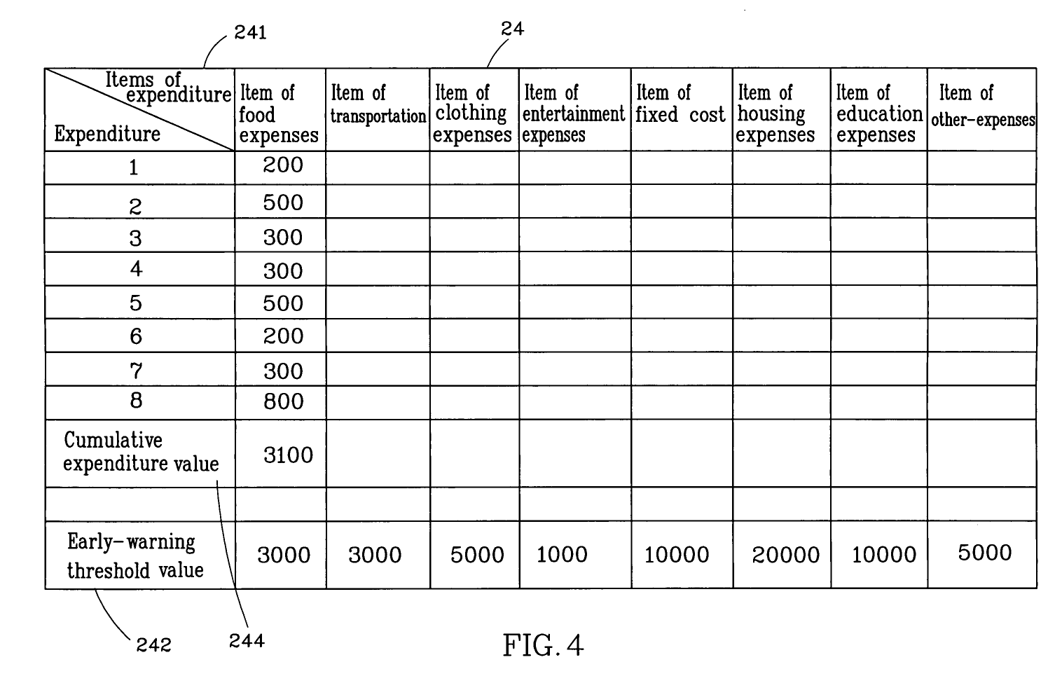

The operation and memory circuit 21 is electrically connected with the set of numeric keys 15, the set of function keys 16 and the display screen 12, comprising an Autorun Program 22, an account statement 24 and a warning program 26. The account statement 24 features multiple items of expenditure 241 including the item of food expenses, the item of transportation expenses, the item of clothing expenses, the item of entertainment expenses, the item of fixed cost, the item of housing expenses, the item education expenses and the item of other-expenses. As shown in FIG. 4, each item of expenditure has an early-warning threshold value 242 and a cumulative expenditure value 244. When the cumulative expenditure value 244 surpasses the early-warning threshold value 242, the warning program 26 immediately executes a warning action.

The speaker 18 is mounted in the housing 1 and electrically connected to the operation and memory circuit 21. The aforesaid warning action is that the warning program 26 is controlled by the operation and memory circuit 21 to output a warning sound through the speaker 18.

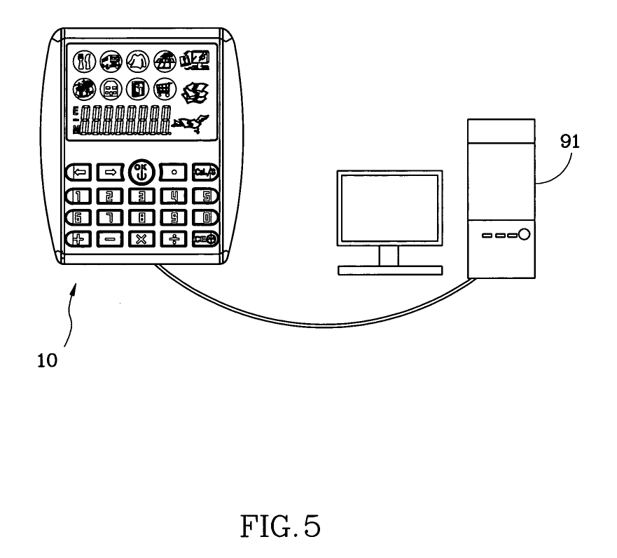

The connection interface 19 is electrically connected to the operation and memory circuit 21, and adapted for connection to a computer 91 (see FIG. 5). According to the present preferred embodiment, the connection interface 19 is USB (Universal Serial Bus) interface.

After connection of the connection interface 19 to a computer 91, the Autorun Program 22 runs automatically for enabling the computer 91 to access to the account statement 24. Thus, a user can use the computer 91 to access to the account statement 24, thereby checking and editing the value of each item of expenditure.

Further, the icons 121 on the display screen 12 include an overdraft icon 122, as shown in FIG. 1. The aforesaid warning action includes the action that the operation and memory circuit 21 drives the warning program 26 to have the overdraft icon 122 be displayed on the display screen 12.

The operation of the electronic accounting machine is outlined hereinafter.

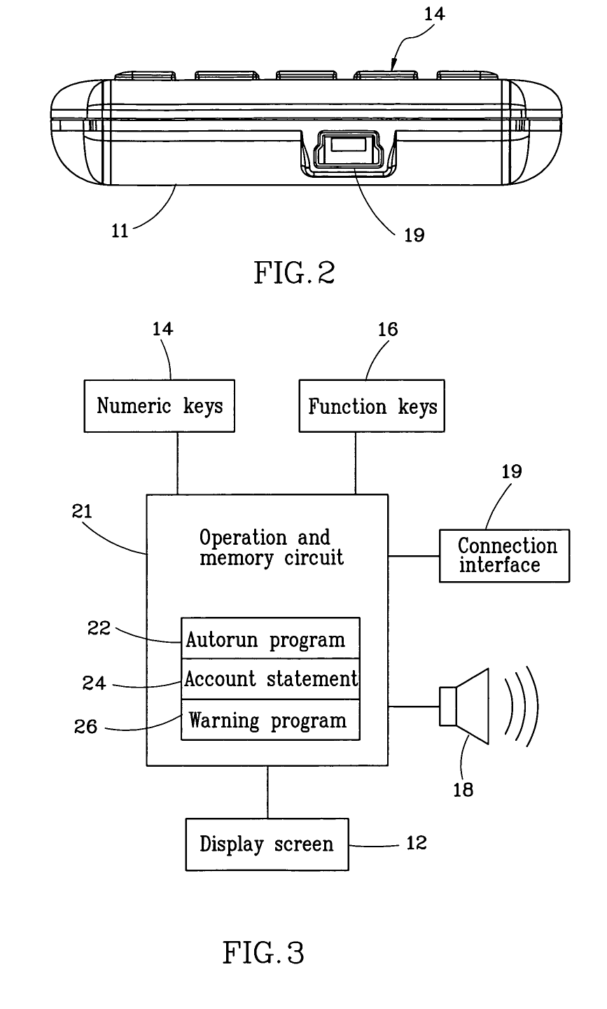

Referring to FIG. 5 and FIG. 1, before operation, the user connects the connection interface 19 (see FIG. 2) to a computer 91. At this time, the Autorun Program 22 runs automatically for enabling the computer 91 to access to the account statement 24 (see FIG. 4). Thus, the user can operate the computer 91 to access to the account statement 24, setting the early-warning threshold value 242 for each item of expenditure, for example, the early-warning threshold value 242 for the item of food expenses to be US$3,000.

Thereafter, when paying a food expense, the user can use the two directional keys 16A to select the food expenditure icon. During actual practice, a flashing mode is executed to indicate the selected icon. By means of the set of numeric keys 14, the user can input the amount of a food expense and then press the OK (ENTER) key 16C, making an entry in the account. The operation and memory circuit 21 records the amount of the food expense in the account statement 24, and adds the amount to the respective cumulative expenditure value 244. If the cumulative expenditure value 244 is under the corresponding early-warning threshold value 242, the warning program 26 does no work. If the cumulative expenditure value 244 surpasses the corresponding early-warning threshold value 242, the warning program 26 immediately executes the warning action, causing the warning program 26 to be controlled by the operation and memory circuit 21 to output a warning sound through the speaker 18, and at the same time and to have the overdraft icon 122 be displayed on the display screen 12.

The operation keys 16D enable the user to assign the operation rule. The Alter key 16S is used for switching between the accounting mode and the calculator mode so that the user can use the electronic accounting machine for accounting as well as for calculation.

As stated above, except the function of accounting, the electronic accounting machine of the present invention gives an overdraft warning for every item of expenditure, reminding the user to control the expenditure. Further, the electronic accounting machine uses the Autorun Program 22 to run the program automatically when the machine is connected to a computer 91, facilitating access to the account statement 24 without the need to install an extra driver. Therefore, the invention facilitates installation and use.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electronic accounting machine, comprising:
a housing;
a display screen mounted on said housing, said display screen carrying a set of icons respectively controllable to display and not to display, said display screen defining a numeric data display zone;
a set of numeric keys mounted on said housing and featuring digits 0 to 9 and a decimal point (.);
a set of function keys mounted on said housing, said set of function keys comprising two directional keys, an ENTER key, an alter key and a plurality of operation keys;
an operation and memory circuit electrically connected with said set of numeric keys, said set of function keys and said display screen, said operation and memory circuit comprising an Autorun Program, an account statement and a warning program, said account statement featuring a plurality of items of expenditure, each item of expenditure having an early-warning threshold value and a cumulative expenditure value, said warning program executing a warning action when the cumulative expenditure value surpasses said early-warning threshold value; and
a connection interface electrically connected to said operation and memory circuit and adapted for connecting to an external computer for enabling said Autorun Program to run automatically to let a user of said external computer access to said account statement.

2. The electronic accounting machine as claimed in claim 1, wherein said display screen is disposed at a top side relative to said set of numeric keys and said set of function keys.

3. The electronic accounting machine as claimed in claim 1, wherein the display locations of said icons are above the location of said numeric data display zone.

4. The electronic accounting machine as claimed in claim 1, wherein said set of icons comprises a food expenditure icon, a transportation expenditure icon, a clothing expenditure icon, an entertainment expenditure icon, a fixed cost icon, a housing expenditure icon, an education expenditure ion and an other-expenditure icon.

5. The electronic accounting machine as claimed in claim 1, wherein said connection interface is a USB (Universal Serial Bus) interface.

6. The electronic accounting machine as claimed in claim 1, wherein said account statement features at least one of a plurality of items of expenditure including the item of food expenses, the item of transportation expenses, the item of clothing expenses, the item of entertainment expenses, the item of fixed cost icon, the item of housing expenses, the item education expenses and the item of other-expenses.

7. The electronic accounting machine as claimed in claim 6, further comprising a speaker mounted in said housing and electrically connected to said operation and memory circuit for output of a warning sound subject to the control of said warning program when said cumulative expenditure value surpasses said early-warning threshold value.
